(19) United States
(12) Patent Application Publication
(10) Pub. No.: US 2014/0078188 A1
(43) Pub. Date: Mar. 20, 2014

(54) DRIVING DEVICE OF DISPLAY DEVICE

(71) Applicant: SAMSUNG DISPLAY CO., LTD., Yongin-City (KR)

(72) Inventors: Eui-Dong HWANG, Bucheon-si (KR); Bon-Sung KOO, Seongnam-si (KR); Jun Dal KIM, Dong-gu (KR); Jong Jae LEE, Asan-si (KR); Se Young HEO, Seoul (KR)

(73) Assignee: SAMSUNG DISPLAY CO., LTD., Yongin-City (KR)

(21) Appl. No.: 13/740,711

(22) Filed: Jan. 14, 2013

(30) Foreign Application Priority Data
Sep. 18, 2012 (KR) 10-2012-0103157

(51) Int. Cl. G09G 3/36

(52) U.S. Cl. CPC G09G 3/3622
USPC 345/690

(57) ABSTRACT

A driving device of a display device includes: a reference voltage generator configured to receive a high potential power supply voltage, a low potential power supply voltage and a medium power supply voltage and to generate reference voltages between the high potential power supply voltage and the low potential power supply voltage, where the low potential power supply voltage is lower than the high potential power supply voltage, and the medium power supply voltage has a value between the high potential power supply voltage and the low potential power supply voltage; a gray reference voltage generator configured to receive and divide the reference voltages and to generate gray reference voltages; and a data driver configured to receive the gray reference voltages and the high and medium potential power supply voltages, and to generate data voltages using the gray reference voltages and the high and medium potential power supply voltages.

This application claims priority to Korean Patent Application No. 10-2012-0103157, filed on Sep. 18, 2012, and all the benefits accruing therefrom under 35 U.S.C. §119, the content of which in its entirety is herein incorporated by reference.

### BACKGROUND

(a) Field

Exemplary embodiments of the invention relates to a driving device of a display device, and more particularly, to a driving device of a display device for generating a gray reference voltage, in which damage to the driving device is effectively prevented.

(b) Description of the Related Art

A display device, such as a liquid crystal display (“LCD”) and an organic light emitting diode display, for example, generally includes a display panel and a driving device for driving the display device.

The display panel includes a plurality of signal lines and a plurality of pixels connected to the signal lines and arranged substantially in a matrix form. The signal lines include a plurality of gate lines that transfers gate signals, a plurality of data lines that transfers data voltages, and the like.

Each pixel may include at least one switching element connected to a corresponding gate line and a corresponding data line, at least one pixel electrode connected to the switching element, and an opposed electrode that faces the pixel electrode and receives a common voltage. The switching element may include at least one thin film transistor, and may selectively transfer a data voltage transferred by the data line which is turn on or off according to a gate signal transferred by the gate line, to the pixel electrode. Each pixel may display an image having the corresponding luminance according to the data voltage applied to the pixel electrode.

The driving device includes a gate driver generating gate signals and a data driver generating data voltages, a gray reference voltage generator supplying a gray reference voltage to the data driver, a signal controller controlling the gate driver, the data driver, and the gray reference voltage generator, and the like. The drivers may be installed on the display panel in at least one integrated circuit (“IC”) chip form, attached to the display panel in a tape carrier package (“TCP”) form, or integrated on the display panel.

The driving device converts a digital input image signal including gray information inputted from an external system to an analog image signal by using a gray voltage to supply the analog image signal to each pixel, thereby displaying the image. The gray voltage varies according to gamma data which is information on a gray level and a slope of luminance of the image as a voltage selected as the data voltage in response to a gray of the input image signal.

The gray voltage includes a positive gray voltage and a negative gray voltage based on a common voltage. The gray voltage may be generated from positive and negative gray reference voltages which are smaller than the gray voltage in number.

The gray reference voltage generator of the driving device may receive a power supply voltage or a reference voltage and divides the received voltage to generate the positive and negative gray reference voltages.

The data driver receives the positive and negative gray reference voltages from the gray reference voltage generator and divides the received gray reference voltages to generate gray voltages for all grays. The data driver selects a gray voltage corresponding to the input image signal among a plurality of gray voltages to apply the selected gray voltage as a data voltage to the data line.

### SUMMARY

Exemplary embodiments of the invention provide a driving device of a display device in which a data driver circuit is effectively prevented from being damaged or stressed by effectively preventing a reversion between a gray reference voltage and a power supply voltage inputted to a data driver.

An exemplary embodiment of the invention provides a driving device of a display device, including: a reference voltage generator configured to receive a high potential power supply voltage, a low potential power supply voltage and a medium power supply voltage and to generate a plurality of reference voltages between the high potential power supply voltage and the low potential power supply voltage, where the low potential power supply voltage is lower than the high potential power supply voltage, and the medium power supply voltage has a value between the high potential power supply voltage and the low potential power supply voltage; a gray reference voltage generator configured to receive and divide the reference voltages and to generate a plurality of gray reference voltages; and a data driver configured to receive the gray reference voltages, the high potential power supply voltage and the medium power supply voltage, and to generate a data voltage using the gray reference voltages, the high potential power supply voltage and the medium power supply voltage.

In an exemplary embodiment, the reference voltage generator may include a plurality of resistors connected to each other in series between a terminal of the medium power supply voltage and a terminal of the low potential power supply voltage.

In an exemplary embodiment, the reference voltages may include a plurality of lower reference voltages, which is lower than the medium power supply voltage, and a plurality of upper reference voltages, which is higher than the medium power supply voltage.

In an exemplary embodiment, a voltage difference between a highest voltage of the lower reference voltages and the medium power supply voltage is a first voltage difference, a voltage difference between a lowest voltage of the upper reference voltages and the medium power supply voltage is a second voltage difference, and at least one of the first voltage difference and the second voltage difference may be equal to or greater than a predetermined gap voltage.

In an exemplary embodiment, the upper reference voltages may include a first upper reference voltage and a second upper reference voltage which is lower than the first upper reference voltage, the lower reference voltages may include a first lower reference voltage and a second lower reference voltage which is lower than the first lower reference voltage, the gray reference voltages may include a plurality of positive gray reference voltages, which is higher than the medium power supply voltage and a plurality of negative gray reference voltages, which is lower than the medium power supply voltage, the positive gray reference voltages may include the first and second upper reference voltages and a plurality of output voltages between the first and second upper reference voltages, and the negative gray reference voltages may include the first and second lower reference voltages and a plurality of output voltages between the first and second lower reference voltages.

In an exemplary embodiment, the gray reference voltage generator may receive a gamma data signal corresponding to a gamma curve and generates the gray reference voltages based on the gamma data signal.

In an exemplary embodiment, the reference voltage generator may include a resistor row including a plurality of resistors connected to each other in series between a terminal of the high potential power supply voltage and the terminal of the low potential power supply voltage, and the medium power supply voltage may be supplied to a node between two resistors positioned in a middle portion of the resistor row.

In an exemplary embodiment, the reference voltage generator may include a first reference voltage generator and a second reference voltage generator, which include a resistor row, respectively, the first reference voltage generator may include a first resistor row including a plurality of resistors connected to each other in series between the terminal of the high potential power supply voltage and the terminal of the low potential power supply voltage, and the second reference voltage generator may include a second resistor row connected to each other in series between the terminal of the medium power supply voltage and the terminal of the low potential power supply voltage.

In an exemplary embodiment, a lowest voltage among the reference voltages outputted by the first reference voltage generator may be higher than the medium power supply voltage, and a highest voltage among the reference voltages outputted by the second reference voltage generator may be lower than the medium power supply voltage.

In an exemplary embodiment, the data driver may divide the gray reference voltages and generate a plurality of gray voltages, and the data driver may select a gray voltage corresponding to a gray of an input image signal among the gray voltages and output the selected gray voltage as the data voltage.

In an exemplary embodiment, the gray reference voltage generator may be disposed in the data driver.

According to one or more exemplary embodiments of the invention, a data driver circuit is effectively prevented from being damaged or stressed by effectively preventing a reversion between a gray reference voltage and a power supply voltage inputted to a data driver.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an exemplary embodiment of a display device according to the invention;

FIG. 2 is a circuit diagram showing an exemplary embodiment of a reference voltage generator of the display device according to the invention;

FIG. 3 is a block diagram showing an exemplary embodiment of a gray reference voltage generator of the display device according to the invention; and

FIG. 4 is a circuit diagram showing an alternative exemplary embodiment of a reference voltage generator of the display device according to the invention.

### DETAILED DESCRIPTION OF THE EMBODIMENTS

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of a display device according to the invention will be described in further detail with reference to the accompanying drawings.

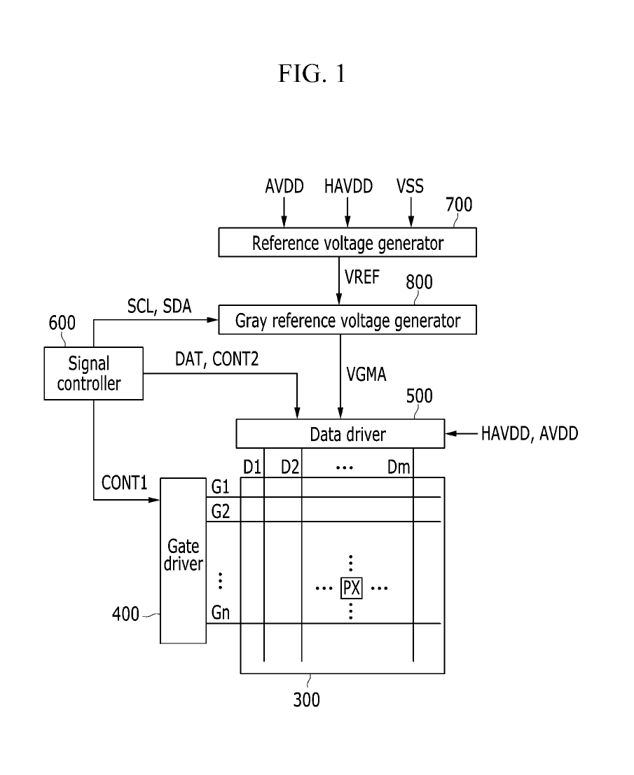

First, an exemplary embodiment of a display device according to an exemplary embodiment of the invention will be described with reference to FIG. 1.

FIG. 1 is a block diagram showing an exemplary embodiment of a display device according to the invention.

Referring to FIG. 1, an exemplary embodiment of a display device according to the invention includes a display panel 300, a gate driver 400 connected to the display panel 300, a data driver 500 connected to the display panel 300, a gray reference voltage generator 800 connected to the data driver 500, a reference voltage generator 700 connected to the gray reference voltage generator 800, and a signal controller (e.g., a timing controller) 600.

The display panel 300 may be a display panel of various flat panel displays (“FPD”) such as a liquid crystal display (“LCD”), an organic light emitting display (“OLED”) and an electrowetting display (“EWD”), for example. In an exemplary embodiment, where the display panel 300 is a display panel of the LCD, the display panel 300 may include lower and upper panels (not illustrated) facing each other and a liquid crystal layer (not illustrated) interposed between the lower and upper panels, when viewed from a cross-sectional structure. The display panel 300 includes a plurality of signal lines and a plurality of pixels PX which is connected to the signal lines and arranged substantially in a matrix form, when viewed from an equivalent circuit.

The signal lines include a plurality of gate lines G1-Gn for transferring gate signals (referred to as “scanning signals”) and a plurality of data lines D1-Dm for transferring data voltages.

Each pixel PX may include a switching element connected to a corresponding gate line of the gate lines G1-Gn and a corresponding data line of the data lines D1-Dm and a pixel electrode connected to the switching element. The switching element may include a thin film transistor, and may be turned on or off based on gate signals transferred by the gate lines G1-Gn and selectively transfer data voltages transferred by the data lines D1-Dm to the pixel electrode. Each pixel PX may display an image having corresponding luminance corresponding to a data voltage applied to the pixel electrode.

In an exemplary embodiment, each pixel PX displays one of primary colors (e.g., spatial division) or alternately displays the primary colors (e.g., temporal division) to display a predetermined color in the spatial or temporal sum of the primary colors. Ina an exemplary embodiment, the primary colors may include three primary colors such as red, green and blue, for example. In an exemplary embodiment, a plurality of adjacent pixels PX which display different primary colors may collectively define a set (referred to as a dot). In such an embodiment, the dot may display a white image.

The signal controller 600 controls the gate driver 400, the data driver 500, the gray reference voltage generator 800, and the like.

The signal controller 600 receives an input image signal and an input control signal that controls a display of the input image signal from an external device, e.g., a graphic controller (not illustrated). The input image signal stores luminance information of each pixel, and the luminance corresponds to a predetermined number of grayscales, for example, 1024 (=2¹⁰), 256 (=2⁸) or 64 (=2⁸) grayscales. In an exemplary embodiment, the input control signal include a vertical synchronization signal and a horizontal synchronization signal, a main clock, data enable signal, and the like. The signal controller 600 processes the input image signal based on the input image signal and the input control signal and generates a gate control signal CONT1, a data control signal CONT2, and the like, and thereafter, transmits the gate control signal CONT1 to the gate driver 400 and transmits the data control signal CONT2 and a processed output image signal DAT to the data driver 500. The output image signal DAT as a digital signal has a grayscale corresponding to a predetermined value.

The signal controller 600 generates a gamma data signal SDA and a clock signal SCL based on gamma data for a gamma curve and transmits the generated gamma data signal SDA and clock signal SCL to the gray reference voltage generator 800 in an inter-integrated circuit (“I²C”) interface mode. The gamma curve is a curve representing luminance or transmittance for a grayscale of the input image signal and may generate a gray voltage or a gray reference voltage based on the gamma curve. The gamma data may be stored in a separate memory (not illustrated).

The reference voltage generator 700 receives a high potential power supply voltage AVDD, a low potential power supply voltage VSS and a medium power supply voltage HAVDD from the outside, generates at least four reference voltages VREF based on the high potential power supply voltage AVDD, the low potential power supply voltage VSS and a medium power supply voltage HAVDD, and transmits the generated reference voltages VREF to the gray reference voltage generator 800. The high potential power supply voltage AVDD and the medium power supply voltage HAVDD may be constant voltages, which may be generated in a power supply voltage supplier (not shown). In an exemplary embodiment, the low potential power supply voltage may be a ground voltage.

The medium power supply voltage HAVDD is a voltage between the high potential power supply voltage AVDD and the low potential power supply voltage and may be about a half of the high potential power supply voltage AVDD, but is not limited thereto and may be variable according to a design condition.

The reference voltage generator 700 generates a plurality of reference voltages VREF by voltage division using a plurality of resistors connected between the high potential power supply voltage AVDD and the medium power supply voltage HAVDD and a plurality of resistors connected between the medium power supply voltage HAVDD and the low potential power supply voltage.

The gray reference voltage generator 800 receives the reference voltages VREF from the reference voltage generator 700 and receives the gamma data signal SDA and the clock signal SCL from the signal controller 600, generates gray reference voltages VGMA based on the gamma data signal SDA and the clock signal SCL and transmits the generated gray reference voltages VGMA to the data driver 500. The gray reference voltages VGMA include a positive gray reference voltage and a negative gray reference voltage. The number of the gray reference voltages VGMA may be greater than the number of reference voltages VREF.

In an exemplary embodiment, the gray reference voltage generator 800 may be included in the data driver 500.

In an exemplary embodiment, the data driver 500 receives and divides the gray reference voltage VGMA from the gray reference voltage generator 800, and generates a plurality of gray voltages. In such an embodiment, the data driver 500 receives the data control signal CONT2 and the output image signal DAT from the signal controller 600 and selects a gray voltage corresponding to each output image signal DAT to convert the output image signal DAT into a data voltage, which is an analog data signal. The data control signal CONT2 includes a horizontal synchronization start signal for notifying a transmission starting of the output image signal DAT for a pixel PX in one row and a load signal for instructing that the data voltage is applied to the data lines D1-Dm. The data control signal CONT2 may further include an inversion signal for inverting a polarity of the data voltage for a common voltage (referred to as a polarity of the data voltage). The data driver 500 is connected to the data lines D1-Dm of the display panel 300 to apply the data voltage to the corresponding data lines D1-Dm.

In an exemplary embodiment, the data driver 500 receives and uses the high potential power supply voltage AVDD and the medium power supply voltage HAVDD from the outside. The data driver 500 includes a buffer that outputs the data voltage, and the buffer may include an amplifier connected to the high potential power supply voltage AVDD and the medium power supply voltage HAVDD. The buffer may also be connected to the low potential power supply voltage VSS.

The gate driver 400 receives the gate control signal CONT1 from the signal controller 600 and generates a gate signal including a gate-on voltage that turns on the switching element of the pixel PX and a gate-off voltage that turns off the switching element based thereon. The gate control signal CONT1 includes a scanning start signal for instructing a scanning start, a gate clock signal for controlling an output timing of the gate-on voltage, a low voltage, and the like. The gate driver 400 is connected to the gate lines G1-Gn of the display panel 300 to apply the gate signal to the gate lines G1-Gn.

When the gate driver 400 sequentially applies gate-on pulses including the gate-on voltages to the gate lines G1-Gn to turn on the switching element of a corresponding pixels of the pixels PX connected to the gate lines G1-Gn, the data voltage applied to the data lines D1-Dm is applied to the corresponding pixel PX through the turned-on switching element. When the data voltage is applied to the corresponding pixel PX, the corresponding pixel PX may display luminance corresponding to the data voltage through various optical conversion elements. In one exemplary embodiment, for example, where the display panel 300 is a display panel of the LCD, an inclined degree of liquid crystal molecules of the liquid crystal layer is controlled to control polarization of light, thereby displaying luminance corresponding to the grayscale of the input image signal.

By repeating the above-described process every horizontal period, the gate-on voltages are sequentially applied to all of the gate lines G1-Gn and the data voltages are applied to all of the pixels PX to display images of a frame.

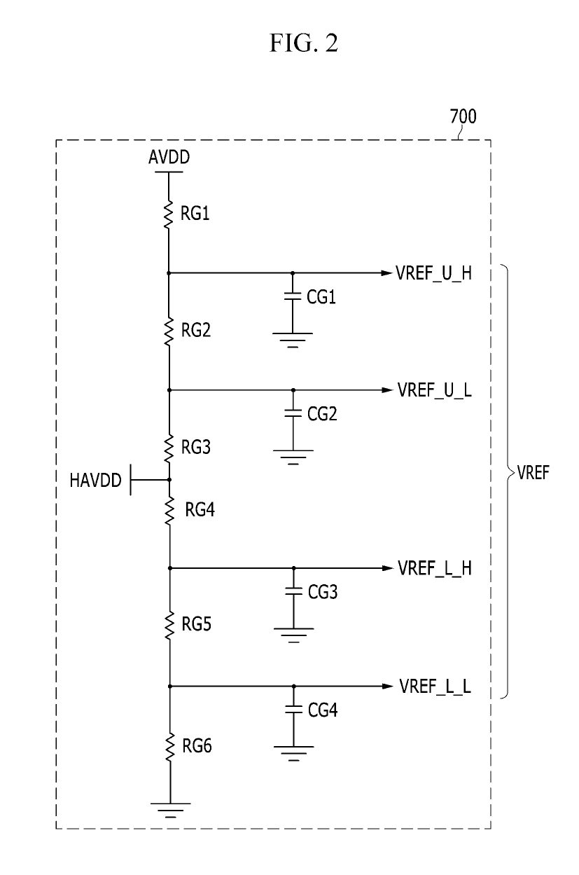

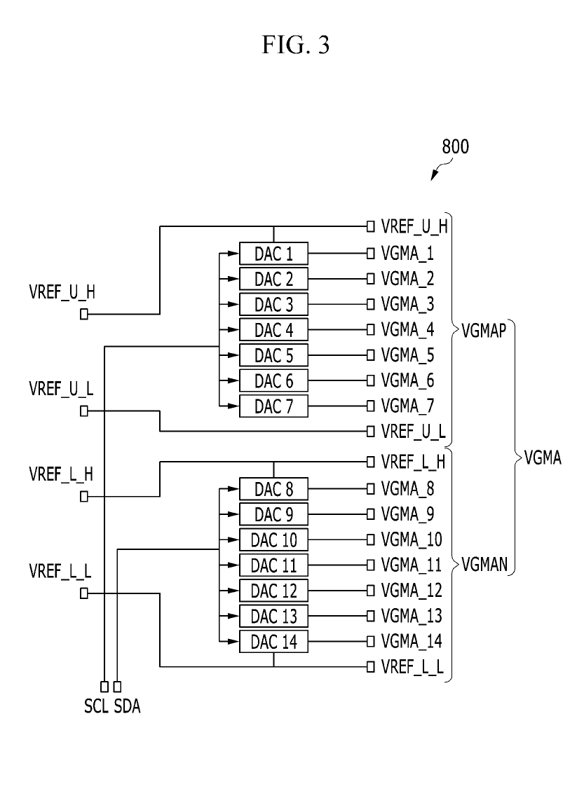

Now, an exemplary embodiment of a reference voltage generator and an exemplary embodiment of a gray reference voltage generator of the display device according to the invention will be described with reference to FIGS. 2 and 3.

FIG. 2 is a circuit diagram of an exemplary embodiment of a reference voltage generator of the display device according to t the invention, and FIG. 3 is a block diagram of an exemplary embodiment of a gray reference voltage generator of the display device according to the invention.

Referring to FIG. 2, the reference voltage generator 700 of the display device according to the exemplary embodiment of the invention includes a resistor row, e.g., a single resistor row, including a plurality of resistors, e.g., a first to sixth resistors RG1-RG6, connected to each other in series between the high potential power supply voltage AVDD and the low potential power supply voltage VSS. In an exemplary embodiment, as shown in FIG. 2, the low potential power supply voltage VSS is a ground voltage.

In an exemplary embodiment, a node between the two resistors, e.g., the third and fourth resistor RG3 and RG4, which are positioned in a center portion of the resistors RG1-RG6 and connected to each other in series, is connected to the medium power supply voltage HAVDD. In such an embodiment, upper resistors, e.g., the first to third resistors RG1-RG3, which are disposed in an upper portion of the resistors RG1-RG6 with reference to the node, are connected between the high potential power supply voltage AVDD and the medium power supply voltage HAVDD, and lower resistors, e.g., the fourth to sixth resistors RG4-RG6, which are disposed in a lower portion of the resistors RG1-RG6 with respect to the node, are connected between the medium power supply voltage HAVDD and the low potential power supply voltage VSS. Parasitic capacitors CG1, CG2, CG3 and CG4 may be connected to nodes between two adjacent resistors of the resistors RG1-RG6. The electrical resistances of the resistors RG1-RG6 may vary according to a design condition of the display device.

In an exemplary embodiment, the upper resistors RG1-RG3 divide a voltage between the high potential power supply voltage AVDD and the medium power supply voltage HAVDD and generate two upper reference voltages, e.g., a high upper reference voltage VREF_U_H (also referred to as a first upper reference voltage) and a low upper reference voltage VREF_U_L (also referred to as a second reference voltage). In such an embodiment, the lower resistors RG4-RG6 divide a voltage between the medium power supply voltage HAVDD and the low potential power supply voltage VSS and generates two lower reference voltages, e.g., a high lower reference voltage VREF_L_H (also referred to as a first lower reference voltage) and a low lower reference voltage VREF_L_L (also referred to as a second lower reference voltage). The upper reference voltages VREF_U_H and VREF_U_L and the lower reference voltages VREF_L_H and VREF_L_L define a plurality of reference voltages VREF together. The magnitudes and the order of the upper and lower reference voltages VREF_U_H, VREF_U_L, VREF_L_H and VREF_L_L may be determined according to the electrical resistances of the resistors RG1-RG6.

The generated upper and lower reference voltages VREF_U_H, VREF_U_L, VREF_L_H and VREF_L_L are inputted to the data driver 500 through the gray reference voltage generator 800 together with the high potential power supply voltage AVDD and the medium lower supply voltage HAVDD.

In an exemplary embodiment of the invention, the lower upper reference voltage VREF_U_L, which is the lower voltage of the upper reference voltages VREF_U_H and VREF_U_L, always has a higher potential than the medium power supply voltage HAVDD, such that a reversion phenomenon between the low upper reference voltage VREF_U_L and the medium power supply voltage HAVDD when turning on or off the driving device including the data driver 500 is effectively prevented. In such an embodiment, the high lower reference voltage VREF_L_H, which is the higher voltage of the lower reference voltages VREF_L_H and VREF_L_L, always has a lower potential than the medium power supply voltage HAVDD, such that a reversion phenomenon between the lower reference voltage VREF_L_H and the medium power supply voltage HAVDD when turning on or off the driving device including the data driver 500 is effectively prevented. In such an embodiment, the driving device such as the data driver 500 is effectively prevented from being damaged or stressed due to the reversion between the medium power supply voltage HAVDD and the reference voltages which are near to the medium power supply voltage HAVDD, e.g., the low upper reference voltage VREF_U_L and the high lower reference voltage VREF_L_H.

In an exemplary embodiment, a voltage difference between the low upper reference voltage VREF_U_L and the medium power supply voltage HAVDD may be maintained at a predetermined gap voltage or more, and a voltage difference between the high lower reference voltage VREF_L_H and the medium power supply voltage HAVDD may be maintained at a predetermined gap voltage or more such that the reversion between the medium power supply voltage HAVDD and the high lower reference voltages VREF_L_H is effectively prevented from occurring due to external noise, signal ripple, or the like. In an exemplary embodiment, a voltage difference between the high potential power supply voltage AVDD and the high upper reference voltage VREF_U_H, which is the nearest to the high potential power supply voltage AVDD, and a voltage difference between the low potential power supply voltage VSS, e.g., the ground voltage, and the low lower reference voltage VREF_L_L, which is the nearest to the low potential power supply voltage VSS, may also be maintained at a predetermined gap voltage or more. The predetermined gap voltage may be about 0.2 volt (V) or more, but is not limited thereto and may vary according to a design condition. In such an embodiment, the electrical resistance of the resistors RG1-RG6 may be determined such that a voltage difference between the adjacent nodes may be maintained at a predetermined gap voltage or more.

The number of the resistors RG1-RG6 or the number of the reference voltages VREF is not limited to the exemplary embodiment shown in FIG. 2, and may be vary according to a design condition of the display device.

Next, referring to FIG. 3, an exemplary embodiment of the gray reference voltage generator 800 of the display device according to the invention includes a plurality of input terminals, a plurality of upper digital-to-analog converters, e.g., a first to seventh digital-to-analog converters DAC1-DAC7, and a plurality of lower digital-to-analog converters, e.g., eighth to fourteenth digital-to-analog converters DAC8-DAC14, and a plurality of output terminals that outputs the gray reference voltages VGMA.

The input terminals of the gray reference voltage generator 800 receive the upper and lower reference voltages VREF_U_H, VREF_U_L, VREF_L_H and VREF_L_L from the reference voltage generator 700.

The upper digital-to-analog converters DAC1-DAC7 are connected between the upper reference voltages VREF_U_H and VREF_U_L and receive the gamma data signal SDA and the clock signal SCL from the signal controller 600.

In an exemplary embodiment, the upper digital-to-analog converters DAC1-DAC7 may include a resistor row including a plurality of resistors, which is connected to each other in series between the upper reference voltages VREF_U_H and VREF_U_L. The upper digital-to-analog converters DAC1-DAC7 may select a voltage of a node between the resistors included in the resistor row based on the gamma data signal SDA and the clock signal SCL, and may output a plurality of gray reference voltages VGMA_{—}1 to VGMA_{—}7.

In such an embodiment, the lower digital-to-analog converters DAC8-DAC14 may include a resistor row including a plurality of resistors, which is connected to each other in series between the lower reference voltages VREF_L_H and VREF_L_L. The lower digital-to-analog converters DAC8-DAC14 may select a voltage of a node between the resistors included in the resistor row based on the gamma data signal SDA and the clock signal SCL, and may output a plurality of gray reference voltages VGMA_{—}8 to VGMA_{—}14.

The number of the gray reference voltages VGMA_{—}1 to VGMA_{—}14 is not limited to the exemplary embodiment shown in FIG. 3, and may vary according to a design condition.

The upper and lower digital-to-analog converters DAC1-DAC14 may include a buffer (not illustrated) for amplifying the converted analog voltages.

The upper reference voltages VREF_U_H and VREF_U_L and the gray reference voltages VGMA_{—}1 to VGMA_{—}7 having values therebetween collectively define a positive gray reference voltage VGMAP, and the lower reference voltages VREF_L_H and VREF_L_L and the gray reference voltages VGMA_{—}8 to VGMA_{—}14 having values therebetween collectively define a negative gray reference voltage VGMAN. The positive gray reference voltage VGMAP has a positive polarity with respect to the common voltage, and the negative gray reference voltage VGMAN has a negative polarity with respect to the common voltage.

The output terminals of the gray reference voltage generator 800 outputs the gray reference voltage VGMA including the positive gray reference voltage VGMAP and the negative gray reference voltage VGMAN to the data driver 500.

As described above, the upper reference voltage VREF_U_L, which is the lowest voltage of the positive gray reference voltage VGMAP, is always higher than the medium power supply voltage HAVDD, and the lower reference voltage VREF_L_H, which is the highest voltage of the negative gray reference voltage VGMAN, is always lower than the medium power supply voltage HAVDD. Accordingly, when the voltage differences between the upper reference voltage VREF_U_L and the lower reference voltage VREF_L_H and the medium power supply voltage HAVDD are maintained at the predetermined gap voltage or more, and voltage reversion between the positive gray reference voltage VGMAP and the medium power supply voltage HAVDD or voltage reversion between the negative gray reference voltage VGMAN and the medium power supply voltage HAVDD is thereby effectively prevented.

In an exemplary embodiment, where the data driver 500 uses the medium power supply voltage HAVDD as the power supply voltage, the medium power supply voltage HAVDD is reversed with the positive gray reference voltage VGMAP or the negative gray reference voltage VGMAN to exceed a predetermined internal pressure condition of the data driver 500, such that the driving circuit of the data driver 500 is effectively prevented from being damaged and stressed.

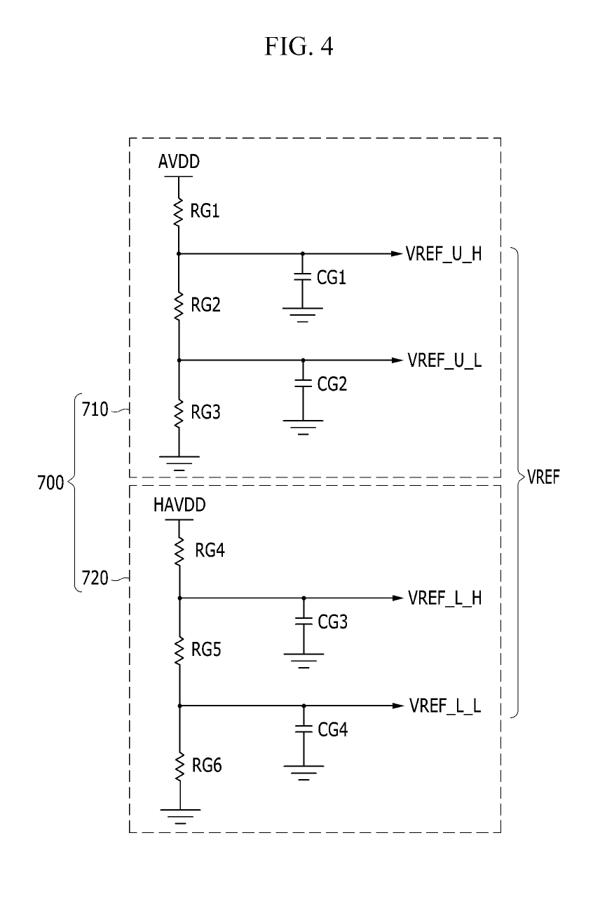

Next, an alternative exemplary embodiment of a reference voltage generator of the display device according to the invention will be described with reference to FIG. 4.

FIG. 4 is a circuit diagram of an alternative exemplary embodiment of a reference voltage generator of the display device according to the invention. Referring to FIG. 4, an alternative exemplary embodiment of the reference voltage generator includes a first reference voltage generator 710 and a second reference voltage generator 720.

The first reference voltage generator 710 includes a resistor row, e.g., a single resistor row, including a plurality of resistors, e.g., first to third resistors RG1-RG3, connected to each other in series between the high potential power supply voltage AVDD and the low potential power supply voltage VSS, e.g., a ground voltage. The resisters RG1-RG3 in the first reference voltage generator 701 divide a voltage between the high potential power supply voltage AVDD and the low potential power supply voltage VSS, and generates two upper reference voltages, e.g., a high upper reference voltage VREF_U_H and a low upper reference voltage VREF_U_L.

The second reference voltage generator 720 includes a resistor row, e.g., a single resistor row, including a plurality of resistors, e.g., fourth to sixth resistors RG4-RG6, connected to each other in series between the medium power supply voltage HAVDD and the low potential power supply voltage VSS, e.g., a ground voltage. The resisters RG4-RG6 in the second reference voltage generator 720 divide a voltage between the medium power supply voltage HAVDD and the low potential power supply voltage VSS, and generates two lower reference voltages VREF_L_H and VREF_L_L.

Electrical resistances of the RG1-RG6 may be determined according to a design condition.

Parasitic capacitors CG1, CG2, CG3 and CG4 may be connected to nodes between two adjacent resistors RG1-RG6.

The upper reference voltages VREF_U_H and VREF_U_L and the lower reference voltages VREF_L_H and VREF_L_L collectively define a plurality of reference voltages VREF. The magnitudes and the order of the upper and lower reference voltages VREF_U_H, VREF_U_L, VREF_L_H and VREF_L_L may be determined according to the electrical resistances of the resistors RG1-RG6.

The generated upper and lower reference voltages VREF_U_H, VREF_U_L, VREF_L_H and VREF_L_L are inputted to the data driver 500 through the gray reference voltage generator 800 together with the high potential power supply voltage AVDD and the medium lower supply voltage HAVDD.

According to an exemplary embodiment of the invention, the lower reference voltage VREF_L_H, which is the higher voltage of the lower reference voltages VREF_L_H and VREF_L_L generated in the first reference voltage generator 710, always has a lower potential than the medium power supply voltage HAVDD, and a reversion phenomenon between the lower reference voltage VREF_L_H and the medium power supply voltage HAVDD when turning on or off the driving device including the data driver 500 is thereby effectively prevented.

The resistors RG1-RG3 in the first reference voltage generator 710 may be designed such that the upper reference voltage VREF_U_L, which is the lower voltage of the upper reference voltages VREF_U_H and VREF_U_L, may always have a higher potential than the medium power supply voltage HAVDD. In such an embodiment, a reversion phenomenon between the upper reference voltage VREF_U_L and the medium power supply voltage HAVDD when turning on or off the driving device including the data driver 500 is effectively prevented.

In an exemplary embodiment, as described above, a voltage difference between the upper reference voltage VREF_U_L and the medium power supply voltage HAVDD and a voltage difference between the lower reference voltage VREF_L_H and the medium power supply voltage HAVDD may be maintained at a predetermined gap voltage or more such that the reversion between the medium power supply voltage HAVDD and the reference voltages VREF_U_L and VREF_L_H is effectively prevented from occurring due to external noise, signal ripple, or the like. In an exemplary embodiment, the predetermined gap voltage may be about 0.2 V or more, but is not limited thereto and may vary according to a design condition. The electrical resistances of the resistors RG1-RG6 may be determined such that a voltage difference between the adjacent nodes may be maintained at a predetermined gap voltage or more.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving device of a display device, comprising:
a reference voltage generator configured to receive a high potential power supply voltage, a low potential power supply voltage and a medium power supply voltage, and to generate a plurality of reference voltages between the high potential power supply voltage and the low potential power supply voltage, wherein the low potential power supply voltage is lower than the high potential power supply voltage, and the medium power supply voltage has a value between the high potential power supply voltage and the low potential power supply voltage;
a gray reference voltage generator configured to receive and divide the reference voltages and to generate a plurality of gray reference voltages; and
a data driver configured to receive the gray reference voltages, the high potential power supply voltage and the medium power supply voltage and to generate a data voltage using the gray reference voltages, the high potential power supply voltage and the medium power supply voltage.

2. The driving device of a display device of claim 1, wherein the reference voltage generator comprises a plurality of resistors connected to each other in series between a terminal of the medium power supply voltage and a terminal the low potential power supply voltage.

3. The driving device of a display device of claim 2, wherein
the reference voltages comprise:
a plurality of lower reference voltages, which is lower than the medium power supply voltage; and
a plurality of upper reference voltages, which is higher than the medium power supply voltage.

4. The driving device of a display device of claim 3, wherein
a voltage difference between a highest voltage of the lower reference voltages and the medium power supply voltage is a first voltage difference, and
a voltage difference between a lowest voltage of the upper reference voltages and the medium power supply voltage is a second voltage difference,
at least one of the first voltage difference and the second voltage difference is equal to or greater than a predetermined gap voltage.

5. The driving device of a display device of claim 4, wherein
the upper reference voltages comprise a first upper reference voltage and a second upper reference voltage, which is lower than the first upper reference voltage,
the lower reference voltages comprise a first lower reference voltage and a second lower reference voltage, which is lower than the first lower reference voltage,
the gray reference voltages comprises a plurality of positive gray reference voltages, which is higher than the medium power supply voltage, and a plurality of negative gray reference voltages, which is higher than the medium power supply voltage,
the positive gray reference voltages comprise the first and second upper reference voltages and a plurality of output voltages between the first and second upper reference voltages, and
the negative gray reference voltages comprise the first and second lower reference voltages and a plurality of output voltages between the first and second lower reference voltages.

6. The driving device of a display device of claim 5, wherein
the gray reference voltage generator receives a gamma data signal corresponding to a gamma curve and generates the gray reference voltages based on the gamma data signal.

7. The driving device of a display device of claim 6, wherein
the reference voltage generator comprises a resistor row comprising a plurality of resistors connected to each other in series between a terminal of the high potential power supply voltage and the terminal the low potential power supply voltage, and
the medium power supply voltage is supplied to a node between two resistors positioned at a middle portion of the resistor row.

8. The driving device of a display device of claim 6, wherein
the reference voltage generator comprises a first reference voltage generator and a second reference voltage generator,
the first reference voltage generator comprises a first resistor row including a plurality of resistors connected to each other in series between a terminal of the high potential power supply voltage and the terminal the low potential power supply voltage, and
the second reference voltage generator comprises a second resistor row connected to each other in series between the terminal of the medium power supply voltage and the terminal of the low potential power supply voltage.

9. The driving device of a display device of claim 8, wherein
a lowest voltage among the reference voltages outputted by the first reference voltage generator is higher than the medium power supply voltage, and
a highest voltage among the reference voltages outputted by the second reference voltage generator is lower than the medium power supply voltage.

10. The driving device of a display device of claim 6, wherein
the data driver divides the gray reference voltages and generates a plurality of gray voltages, and
the data driver selects a gray voltage corresponding to a grayscale level of an input image signal among the gray voltages and outputs the selected gray voltage as the data voltage.

11. The driving device of a display device of claim 10, wherein
the gray reference voltage generator is disposed in the data driver.

12. The driving device of a display device of claim 1, wherein
the reference voltages comprise:
a plurality of lower reference voltages, which is lower than the medium power supply voltage; and
a plurality of upper reference voltages, which is higher than the medium power supply voltage.

13. The driving device of a display device of claim 12, wherein
a voltage difference between a highest voltage of the lower reference voltages and the medium power supply voltage is a first voltage difference, and
a voltage difference between a lowest voltage of the upper reference voltages and the medium power supply voltage is a second voltage difference,
at least one of the first voltage difference and the second voltage difference is equal to or greater than a predetermined gap voltage.

14. The driving device of a display device of claim 12, wherein
the upper reference voltages comprise a first upper reference voltage and a second upper reference voltage, which is lower than the first upper reference voltage,
the lower reference voltages comprise a first lower reference voltage and a second lower reference voltage, which is lower than the first lower reference voltage,
the gray reference voltages comprises a plurality of positive gray reference voltages which are higher than the medium power supply voltage and a plurality of negative gray reference voltages which are lower than the medium power supply voltage,
the positive gray reference voltages comprise the first and second upper reference voltages and a plurality of output voltages between the first and second upper reference voltages, and
the negative gray reference voltages comprise the first and second lower reference voltages and a plurality of output voltages between the first and second lower reference voltages.

15. The driving device of a display device of claim 1, wherein
the gray reference voltage generator receives a gamma data signal corresponding to a gamma curve and generates the gray reference voltages based thereon.

16. The driving device of a display device of claim 1, wherein
the reference voltage generator comprises a resistor row comprising a plurality of resistors connected to each other in series between a terminal of the high potential power supply voltage and a terminal the low potential power supply voltage, and
the medium power supply voltage is supplied to a node between two resistors positioned at a middle portion of the resistor row.

17. The driving device of a display device of claim 1, wherein
the reference voltage generator comprises a first reference voltage generator and a second reference voltage generator,
the first reference voltage generator comprises a first resistor row including a plurality of resistors connected to each other in series between a terminal of the high potential power supply voltage and a terminal of the low potential power supply voltage, and
the second reference voltage generator comprises a second resistor row connected to each other in series between a terminal of the medium power supply voltage and the terminal of the low potential power supply voltage.

18. The driving device of a display device of claim 17, wherein
a lowest voltage among the reference voltages outputted by the first reference voltage generator is higher than the medium power supply voltage, and
a highest voltage among the reference voltages outputted by the second reference voltage generator is lower than the medium power supply voltage.

19. The driving device of a display device of claim 1, wherein
the data driver divides the gray reference voltages and generates a plurality of gray voltages, and
the data driver selects a gray voltage corresponding to a grayscale level of an input image signal among the gray voltages and outputs the selected gray voltage as the data voltage.

20. The driving device of a display device of claim 1, wherein
the gray reference voltage generator is included in the data driver.
